(19) United States
(12) Patent Application Publication
(10) Pub. No.: US 2023/0221721 A1
(43) Pub. Date: Jul. 13, 2023

(54) AN UNMANNED AUTONOMOUS VEHICLE AND METHOD FOR CONTROLLING THE SAME

(71) Applicant: CANON U.S.A., INC., MELVILLE, NY (US)

(72) Inventor: Ryuhei Konno, Plainview, NY (US)

(21) Appl. No.: 17/997,645

(22) PCT Filed: May 7, 2021
(86) PCT No.: PCT/US2021/031343

§ 371 Date: Oct. 31, 2022

Related U.S. Application Data
(60) Provisional application No. 63/022,814, filed on May 11, 2020.

(51) Int. Cl. G05D 1/00; B64U 10/14

(52) U.S. Cl. CPC G05D 1/0094; B64U 10/14; B64U 2101/30

(57) ABSTRACT

An unmanned autonomous vehicle is provided and includes at least one propulsion device, at least one image capture device, at least one adjusting member to adjust an tilt angle of the image capture device and is configured to receive, from a control device, a capturing instruction to capture at least one image, acquire angle information indicating a tilt angle of the image capture device, and control, in a case where the capturing instruction is received, the propulsion device so that the image capture device captures at least one image at an altitude which is determined based on the acquired angle information.

### CROSS-REFERENCE TO RELATED APPLICATIONS

This application claims the benefit of priority from U.S. Provisional Patent Application Ser. No. 63/022814 filed on May 11, 2020, the entirety of which is incorporated herein by reference.

### BACKGROUND

### Field

The present disclosure relates generally to an unmanned autonomous vehicle and method for controlling the vehicle to capture images

### Description of Related Art

Unmanned autonomous vehicles, otherwise known as drones, are known in the art. For consumer use these vehicles are of a size that allows them to be portable and be remotely controlled by a control device. In some instances, these vehicles can be controlled by a dedicated remote control device. In other instances, these vehicles may be controlled by a personal computing device such as a smartphone whereby a user ca control the position and movement of the vehicle by interacting with the screen of the smartphone such that the movement of the drone follows a path defined by the finger of the user as it moves across the screen of the smartphone. These vehicles are also known to include image capturing devices that can be controllable to capture images during flight. However, there is difficulty in controlling an operating these vehicles while attempting to capture images during flight.

For example, much practice is needed in order to correctly interact with the control device in order to move the vehicle to an intended position which, if performed by an inexperienced user, it is difficult to control the position of the vehicle and capture a desired image.

### SUMMARY

According to an aspect of the disclosure, an unmanned autonomous vehicle and method for controlling the vehicle is provided. The vehicle includes at least one propulsion device, at least one image capture device; one or more processors; and one or more memories storing instructions that, when executed, configures the one or more processors to receive a control signal from a control device, the control signal specifying a predetermined distance from an object; control the at least one propulsion device to move the unmanned autonomous vehicle along a predetermined flight path; detect, by the at least one image capture device, the object; continually detect a distance between the unmanned autonomous vehicle and the detected object until the detected distance equals the specified predetermined distance; and control the at least one image capture device to capture at least one image frame including the object for transmission to the control device. According to a further aspect of the disclosure the vehicle is configured to detect an angle of the at least one image capture device; set, based on the detected angle, an altitude value defining an altitude at which the unmanned autonomous vehicle is to fly; control the at least one propulsion device to move the unmanned autonomous vehicle along the predetermined flight path based on the specified distance and the set altitude.

According to another aspect of the disclosure, an unmanned autonomous vehicle is provided and includes at least one propulsion device, at least one image capture device, at least one adjusting member to adjust an tilt angle of the image capture device and a memory storing instructions and one or more processors that, upon executing the stored instructions, configures the unmanned autonomous vehicle to receive, from a control device, a capturing instruction to capture at least one image, acquire angle information indicating a tilt angle of the image capture device, and control, in a case where the capturing instruction is received, the propulsion device so that the image capture device captures at least one image at an altitude which is determined based on the acquired angle information.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1A is an illustrative view of an embodiment of the unmanned autonomous vehicle and control device.

FIG. 1B is a flow diagram detailing exemplary operation of an embodiment.

FIG. 2A is a flow diagram detailing exemplary operation of an embodiment.

FIG. 2B is an illustrative view of an exemplary operation performed in FIG. 2A.

FIG. 2C is a flow diagram detailing exemplary operation of an embodiment.

FIG. 3A is a flow diagram detailing exemplary operation of an embodiment.

FIG. 3B is an illustrative view of the operation detailed in FIG. 3A

FIG. 4 is an illustrative view of an embodiment of the unmanned autonomous vehicle and control device.

FIG. 5 is a flow diagram detailing exemplary operation of an embodiment.

FIG. 6 is a flow diagram detailing exemplary operation of an embodiment.

FIG. 7 is an illustrative view of an embodiment of the unmanned autonomous vehicle.

FIG. 8 is an illustrative view of an embodiment of the unmanned autonomous vehicle and control device.

FIG. 9 is an illustrative view of an embodiment of the control device for controlling the unmanned autonomous vehicle.

FIG. 10A is a flow diagram detailing exemplary operation of an embodiment.

FIG. 10B is an illustrative view of the operation detailed in FIG. 10A

FIG. 11A is an illustrative view of an embodiment of the unmanned autonomous vehicle and control device.

FIG. 11B is an illustrative view of an embodiment of the unmanned autonomous vehicle and control device.

FIG. 12 is an illustrative view of an embodiment of the control device for controlling the unmanned autonomous vehicle.

FIG. 13A is an illustrative view of an embodiment of the unmanned autonomous vehicle and control device.

FIG. 13B is an illustrative view of an embodiment of the unmanned autonomous vehicle and control device.

FIG. 14 is an illustrative view of an embodiment of the control device for controlling the unmanned autonomous vehicle.

FIG. 15 is a block diagram detailing the hardware components of the control device for controlling the unmanned autonomous vehicle.

FIG. 16 is a block diagram detailing the hardware components of the unmanned autonomous vehicle.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DESCRIPTION OF THE EMBODIMENTS

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples.

According to aspects of the disclosure, the above drawbacks are remedied by the unmanned autonomous vehicle (UAV) described hereinafter. Throughout the following description, the UAV may also be referred to simply as a vehicle. In one embodiment, the UAV may be a drone that includes one or more propulsion devices that propel the drone along a particular flight path. The UAV described herein is operable to follow predetermined flight paths. The UAV may continually detect objects via an image capture device in order to follow the predetermined flight path while focusing the image capture device on one or more of the detected objects. As used herein, the term object refers to humans or animals. However, the term object may also include inanimate objects such as flowers or landscapes or other objects to be imaged. During the predetermined flight plan, using the continuous object detection, the vehicle is controlled to be in a position such that the image capturing device mounted thereon can be optimally positioned in order to capture an image of at least a portion of the object being continually monitored. In certain embodiments, a position of the image capturing device on the vehicle selectively modifies the predetermined flight plan in order to ensure that the vehicle is optimally positioned to capture the image. The selective positioning of the image capture device may, in some instances, be controlled by a user via a control device. In other instances, the position of the image capture device may be automatically repositioned such that one or more of a predetermined distance from the object is maintained and a predetermined image capture angle is maintained.

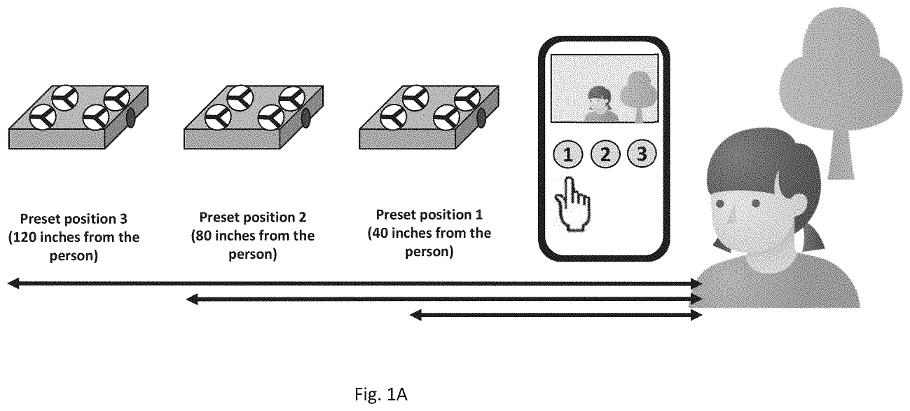

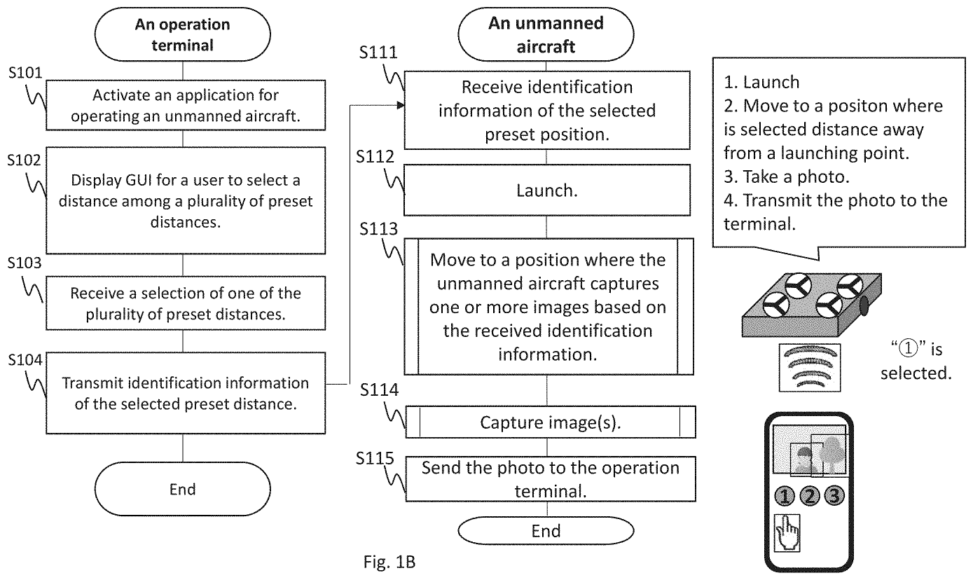

FIG. 1A illustrates a UAV and device for controlling the UAV. The UAV as shown herein is a drone that includes at least one propulsion device that is controlled to cause the UAV to take off from a stopped position where the UAV is supported, rise in the air, and fly a particular flight pattern. The UAV includes a housing that supports at least one propulsion device that is capable of causing the housing to lift off from a supported position and fly the particular flight pattern. The housing may be formed from any material and the at least one propulsion device may be a propeller with one or more blades that is selectively rotatable about one or more axis such that lift if generated which causes the UAV to lift off, fly and land. While referenced here and illustrated in the Figures as a propeller, this is for exemplary purposes only and any device or configuration that is able to generate lift and steer the UAV may be employed. The housing of the UAV also includes at least one image capture device. The at least one image capture device is selectively controllable to capture one or more images of an object (or subject). The housing contains circuitry and hardware for controlling the operation of the UAV. The circuitry may include one or more processors that execute instructions causing control signals to be generated and communicated to the at least one propulsion device for controlling the flight pattern of the UAV as well bidirectionally communicating with the image capture device included in or mounted on the UAV. Thus, the circuitry advantageously enables the UAV to make use of images and other information captured by the image capture device to function as an input for controlling the flight pattern of the UAV as well as using the image capture device to capture one or more images of an object within a field of view of the image capture device.

The UAV is selectively controlled by a control device having an operation panel that selectively receives inputs from a user. As shown in FIG. 1A, is a smartphone having an application executing thereon that generates one or more graphical user interfaces each having one or more user selectable image elements and/or interactive fields that allow a user to selectively input commands that can be communicated to the UAV to control one or more operation thereof. The use of a smartphone as the control device is merely exemplary and it should be understood that any portable computing device may be used to control the UAV including but not limited to, a dedicated controller, a tablet computing device, a wearable computing device, a personal computer and the like.

An exemplary operation of the UAV is illustrated in FIG. 1A. An application executing on the control device generates a graphical user interface that enables the user to interact with the UAV. In this embodiment, the graphical user interface includes a control section and a viewer section. The control section may include at least one user selectable image element that, when selected by the user, causes a control signal to be transmitted according to a predetermined wireless communication protocol to the UAV. The control signal generated by the control device includes one or more control commands for directing one or more components of the UAV to operate in a manner that corresponds to the control command. For example, commands included in the control signal may include instructions on operating the one or more propulsion devices to cause the UAV to fly along a predetermined patter. In another example, the commands included in the control signal may cause the image capture device of the UAV to capture an image of an object (or subject) at a predetermined point during a flight path. In other embodiments, the command included in the control signal can cause the image capture device on the UAV to be moved or repositioned such that the field of view that may be captured by the image control device may be changed. It should be understood that while a discussion of a control signal generated by the control device is presented herein, it should be understood that the a user may interact with the graphical user interface of the control device to generate new, successive, control signals which are communicated to the UAV to further control its operation. The UAV receives the control signal generated by the control device and causes the circuitry within the housing of the UAV to perform one or more control operations based on the commands contained in the received control signal.

The exemplary operation as illustrated in FIG. 1A will be described with respect to the flow diagram illustrated in FIG. 1B. The use case illustrated in FIG. 1A allows for a user to select, one or more image elements are caused to be displayed on the operation panel by a control application that is executing on the control device. The displayed image elements are able to be selected in order to determine a distance away from the object that the UAV is to fly. In this example, the operation panel of the control device, in addition to displaying, in the viewing section, images captured by the image capture device, displays three selectable image elements. Each of the three selectable image elements correspond to a unique distance away from the object displayed in the viewing section that the UAV is to fly such that the image capture device on the UAV can capture one or more image (or sequences of images) of the object at the selected distance. As shown herein, a first distance image element (e.g. icon) indicates a first predetermined position from the object such as forty inches. A second distance image element indicates a second predetermined position from the object such as eighty (80) inches. A third distance image element indicates a third predetermined position from the object such as one hundred and twenty (120) inches. It should be understood that both the number of selectable image elements as well as the specific predetermined distances associated with each are described for purposes of examples only and may be any distance suitable for the UAV to maintain while capturing the image of the object. In other embodiments, the control application may cause a graphical user interface to be generated and displayed on the operation panel that includes one or more input sections that receive input from a user. In this embodiment, the input section on the graphical user interface receives inputs that allow the user to define the predetermined distance to be associated with one of the image elements that are displayed on the operation panel.

FIG. 1B is a flow diagram illustrating the operation shown in FIG. 1A. In operations, steps S101-S104 are performed at the operation terminal of the control device and steps S111-S115 are performed by the UAV. In S101, a control device executes an application by loading instructions into a memory which are then performed by one or more processors. The application executed in S101 is a control application that allows a user to interact with the control application to generate control signals including one or more commands for controlling the operation of the UAV. In S102, the control application causes a graphical user interface (GUI) to be displayed includes one or more user-selectable image elements corresponding to a predetermined flight distance. As shown in FIG. 1A, the GUI on there are three selectable image elements corresponding to the three different distances referenced in FIG. 1A. In S103, the operation panel receives a selection of one of the image elements from the user. In one embodiment, the operation panel is a touch sensitive panel and the input is received by a touch operation from a user. In S104, the control application determines which of the image elements were selected and generates one or more control signals that include one or more commands (e.g. data) that includes identification information corresponding to the selected preset distance. The transmission in S104 is preferably performed via wireless communication using a short distance wireless communication protocol such as Bluetooth® or Bluetooth Low Energy® or longer range wireless communication protocol such as WiFi.

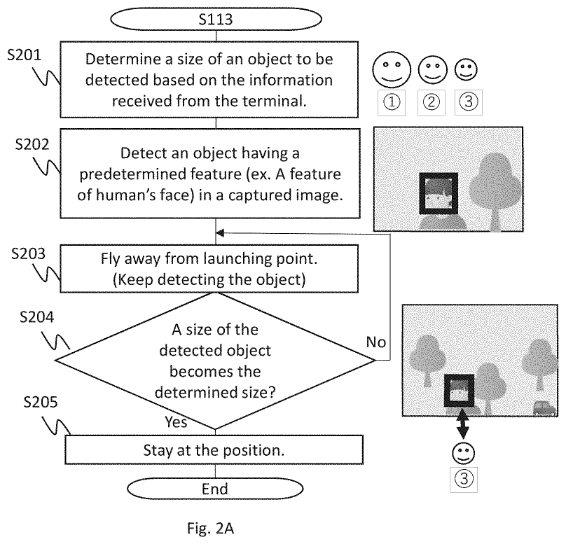

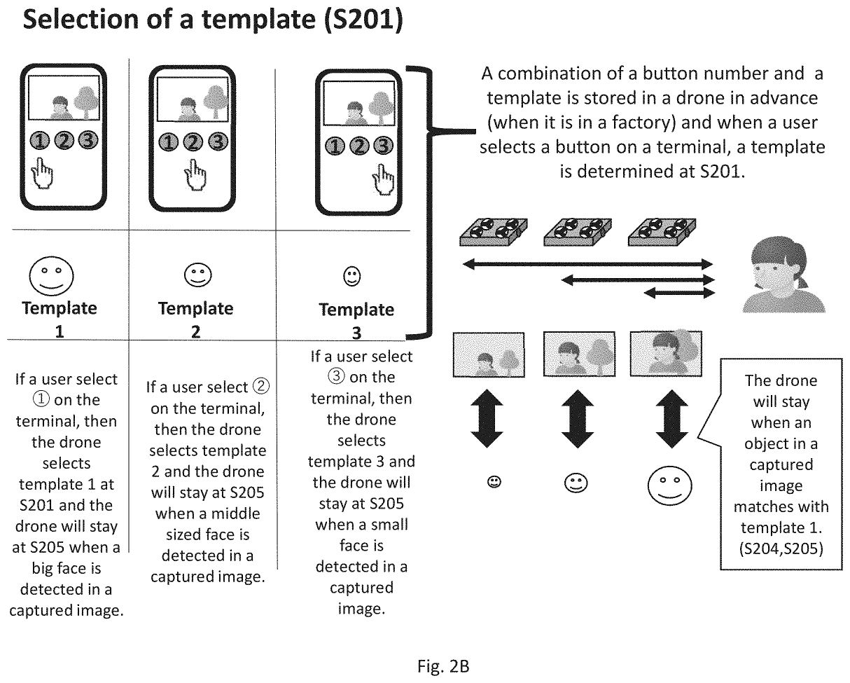

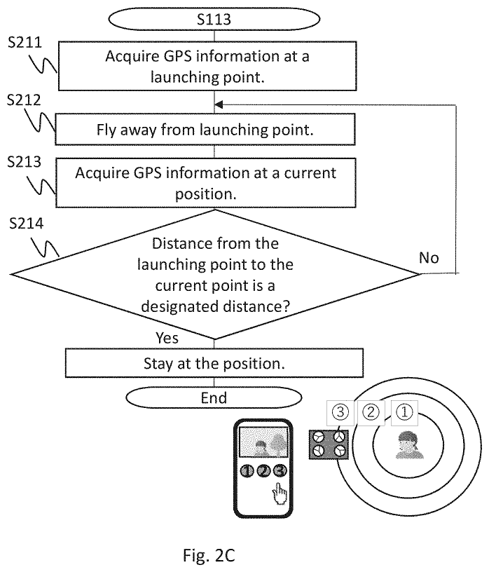

In S111, the UAV receives the control signal generated by the control device which includes the one or more commands for controlling the UAV. UAV parses the control signal to determine the identification information therefrom that will be used to by the circuitry to control operation of the one or more propulsion devices of the UAV. The circuitry of the UAV will use the identification information to initiate the one or more propulsion devices to launch from a rest position one a surface in S112. The rest position may be any surface that supports the UAV when it is not flying such as the ground or in a hand of a user. Upon launch, the UAV is caused to move into a position based on the identification information contained in the control signal such that the UAV can control the image capture device to capture one or more images of the object at the preset distance selected by the user. The manner in which the UAV moves into position includes tracking of the object upon launch in S112 and will be discussed hereinafter with respect to FIGS. 2A-2C. In S114, upon determination by the UAV that the object are at the predetermined distance based on the identification information in the control signal received from the control device, the image capture device is caused to capture one or more images of the object and transmit the captured one or more images back to the control device and display on the operation terminal in S115. It should be understood that the operation in S114 detailing the capturing of images may include capture one or more still images of the object as well as capturing a series of continuous images as video. In yet another embodiment, the image capture device of the UAV used to capture the one or more images includes an audio capture device which can simultaneously capture images and sound from the object which is encoded into a an audio-visual data that is then transmitted back to the control device for output using the display screen of the control device and a speaker of the control device.

Upon capture of the one or more images from the preset distance and transmission of the captured images to the control device, the UAV may be preprogrammed to return to a rest position. This may occur by the UAV capturing and storing images from its initial launch position until the point where the UAV reached the preset distance and designating these images as flight path images. The UAV can, upon return to the rest position capture images as it begins to move back to the rest position by comparing newly captured flight images to the stored flight images to control the one or more propulsion devices to return to the rest position.

Turning now to FIGS. 2A-2C, a more detailed description of the operations performed in step S113 of FIG. 1B will now be described. FIG. 2A details an exemplary algorithm for performing the operation of moving to the preset location of S113 in FIG. 1A. In S201, after the UAV has launched from a rest position, a determination is made by the UAV of a size of an object being detected by the image capture apparatus during flight from the rest position. The determined size of the object is based on the selection of the one or more image elements defining the preset distance to which the UAV is expected to fly from the object or subject. The size determined by the preset distance will be used by the circuitry of the UAV to select an image capture template stored in a memory thereof. In one embodiment, the image capture template includes a representative object to be captured such as a human face and an associated size of the object. During the size determination in S201, the image capture device continually captures images and detects one or more objects in the captured images and, once an object that matches the object in the template is identified, the UAV is controls the one or more propulsion devices of the UAV to move such that a sized of the detected object matches a size of the object/template as set forth in the selected image capture template. In one embodiment, the memory of UAV stores a plurality of templates each corresponding to an expected size of an object according to the preset distance that is selectable at the control device. In another embodiment, the memory of the UAV stores a single image capture template representing the object to be captured and, in response to the identification information that is received from the control device, performs a scaling operation on the image capture template to create, in real-time, modified image capture templates having a larger scale of the identification information indicates that the preset distance is closer than a preset distance associated with the stored image capture template or smaller scale if the present distance associated with the stored image capture template is larger than the preset distance associated with the image capture template. In another embodiment, in addition to templates that are pre-stored in memory of the UAV, the control application executing on the control device may include a template maker function whereby a user can use an image capture device of the control device to capture an image of the object to be captured by the UAV. For example, the template maker function allows a user to capture an image of themselves or of another person nearby or of a pet such that the UAV can fly to the predetermined distance and capture new images from the preset perspective. In another embodiment, a user may select one or more objects within the user-captured image to be the desired object on which the UAV is to focus for the image capture operation in S114 of FIG. 1A.

The image captured by the control device during template maker operation is transmitted to the UAV and stored in memory as a user-defined image capture template. In this instance, included in the information associated with the image captured during the template maker operation is a distance at which the captured object is from the image capture device that captured the image. The UAV may use this information to properly scale the image in the user-defined image capture template to determine an expected corresponding size of the object would be at the various preset distances that are selectable by the control device.

Upon determining the size of the object in S201, during flight, the image capture device of the UAV is controlled to operate the one or more propulsion devices to move and hover while continually capturing images and perform object detection on the captured images to detect the object to be captured. Object detection is based on one or more features of objects in the determined template. For example, if the object in the template is a human face, there are certain features that are stored in the template representing aspects of the face such as eyes, nose, mouth, face size etc. The UAV performs real-time comparison of a live-view of the image being captured by the image capture device such that it is determined that the one or more features of the object from the template are present in the live view image being captured by the image capture device. The live view of this image is transmitted back to the control device and displayed in the viewer section of the GUI on the operation panel allowing the user to visualize what is being captured in real-time.

In S203, the one or more propulsion devices are controlled such that the UAV is caused to fly away from the launch point in order to reach the pre-set distance defined by the identification information in the control signal generated by the control device. The power applied to the one or more propulsion devices is, in part, determined based on the object being detected in S202 such that focus on the object is maintained. In one embodiment, if there are more than one object in the captured image, a user may select one or more of the objects/subjects from within the viewer section on the GUI of the operation panel. In another embodiment, the object can be pre-selected if there are multiple objects/subjects within the captured image frame. For example, if the captured image from contains three human faces, the focus may be automatically placed on the human face closest to the middle of the frame.

While the object is being continually in S203, the UAV executes a size determination algorithm to determine of a size of the detected object in the captured image meets a predetermined object size contained in the image capture template. This operation is continually performed, in real-time, until the result of the determination indicates that the size of the detected object matches the object size in the template at which point the UAV is controlled to maintain a current position (e.g. hover) such that image capture operation can be performed. Further detail of the operations in FIG. 2A are illustrated in FIG. 2B and include the respective steps to which the description applies.

FIG. 2C illustrates an alternative embodiment defining how S113 in FIG. 1A is performed. As shown herein, instead of using object detection to control the one or more propulsion devices of the UAV to fly to the preset distance from the object, the UAV uses global positioning system (GPS) coordinates to control the flight path to reach the preset distance corresponding to the identification information in the control signal. In this embodiment, in S211, GPS coordinates at a launch point are acquired. The GPS coordinates may be acquired by a GPS receiver included in the UAV as part of the operational circuitry. In S212, the UAV launches from its rest position and the one or more propulsions devices on the UAV are caused to direct the UAV along a flight path. During the flight path, the UAV acquires GPS information at a current position in S213 and, in S214, a determination is made as to whether or not current GPS position as compared to the launch point GPS position indicates that the UAV has reached the preset distance selected by the user. In this determination, the image capture template selected by the UAV in response to the identification information in the control signal will include distance information defining the preset distance from which image capture of the object is to occur. The determination in S214 is continually made during the flight path until the result of the determination indicates that the UAV is at the preset distance from the launch point such that the one or more propulsion devices of the UAV are controlled to cause the UAV to maintain its position in S215 in order to perform image capture processing in S114 of FIG. 1B. At the completion of the image capturing operation, the one or more propulsion devices are controlled to move the UAV, using continually obtained GPS information back to the launch position GPS coordinates to return to the rest position. In this embodiment, the UAV detects a distance from the launching point to the current position by using GPS information. However, the UAV may detect the distance by using intensity of radio wave from the control device. The further the unmanned aircraft fly from the control device, the weaker the intensity of radio wave becomes. So the UAV can detect the distance from the control device to the UAV based on the intensity of radio wave. The radio wave may be for example radio wave of Bluetooth or Wi-Fi.

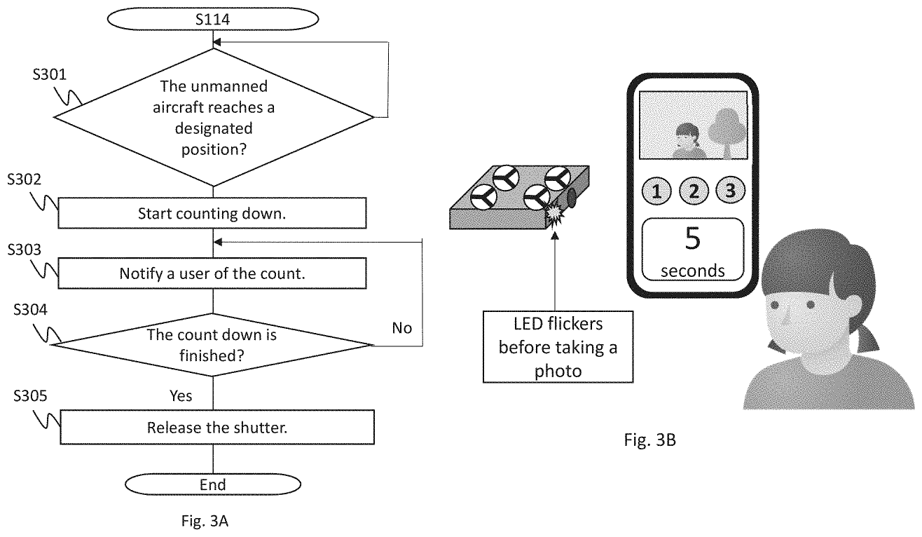

FIGS. 3A and 3B illustrate the image capturing operation of S114 in FIG. 1B. In S301, the determination is made as to whether the UAV has reached the preset (e.g. designated) position. This determination is continuously occurring and is described in FIGS. 2A-2C above. If the determination in S301 is negative, the flight path continues and the determination is repeated. Upon determining in S301 that the UAV has reached the designated position, a countdown process is initiated in S302 whereby a predetermined amount of time until image capture occurs is set. Upon being set the user is notified that the countdown process has been initiated in S303. This is illustrated in FIG. 3B which shows that the UAV has reached the designated position and an indicator is activate to notify the user that the countdown process has begun in S303. In one embodiment, the indicator may be included on the UAV or on the image capture device of the UAV and is controlled to blink or flicker at a predetermined interval to let the user know the countdown has begun. In another embodiment, which can be implemented on its own or in conjunction with the UAV-mounted indicator, the UAV may communicate a message to the control device which, upon receipt thereof, generates a notification to be displayed within the GUI on the operation panel that provides the countdown time to the user. In S304, a determination is made as to whether the countdown is completed and, at the positive determination, the shutter on the image capture device is released in S305. During S305, any number of image capture techniques may be applied in order to obtain an optimal image. For example, the shutter release in S305 may include continuous (e.g. burst) shooting after which all captured images are transmitted to the control device so that an optimal image may be selected by a user via the control application executing on the control device. In another embodiment, shutter release in S305 includes image bracketing whereby various image capture settings are changed continuously as a series of images are captured. For example exposure compensation bracketing may be performed so that you can increase the chance to get the best exposure shot. Another example is white balance (WB) bracketing to get the best color balance under artificial lighting. In yet another operation, high dynamic range (HDR) image capturing may occur whereby a composite image is generated from multiple exposure shots.

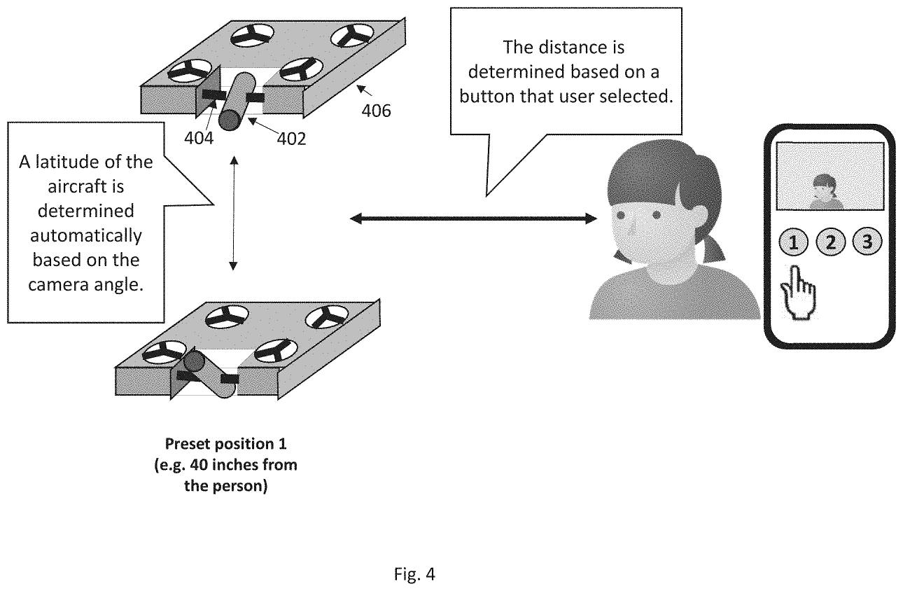

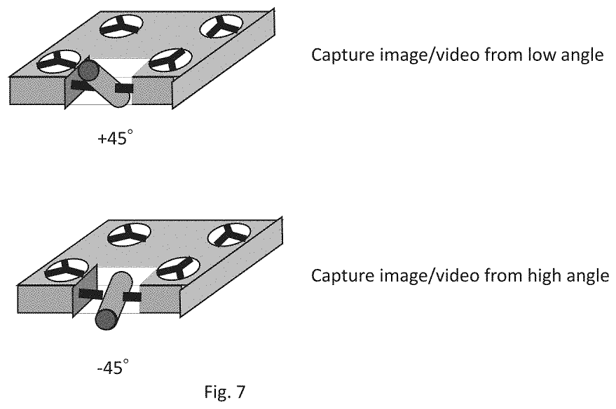

FIG. 4 depicts a further embodiment for controlling the operation of the UAV to capture an image from a preset distance from a user. In this embodiment, the image capture device is moveable such that an angle of the image capture device can be changed. Shown herein, the image capture device 402 is connected to the housing 406 of the UAV by a connection member 404. The image capture device 402 can be moved by the connection member to pivot in a vertical direction to change an angle of the image capture device relative to a surface. In another embodiment, the image capture device 402 may selectively pivot about the connection member 404 to change the angle of the image capture device relative to the surface. The ability of the image capture device 402 to move and change angles is used to control an altitude of the UAV during the image capture operation. In one embodiment, a user manually positions the image capture device in a particular position. In another embodiment, the predetermined distance settings associated with the image elements displayed on the operation panel also include preset camera angle values that, when selected, are interpreted by the UAV to control the position of the image capture device to reach the preset camera angle and, in doing so, causes the flight path of the UAV to be modified such that, once the preset distance from the object is reached, the altitude of the UAV is modified based on the camera angle value associated with the selected setting. For example, if a vertical value of the image capture device is negative, the image capture device is controlled to have an image capture field below an underside of the UAV and in a direction towards the ground. In this instance, an altitude of the UAV is caused to increase above the surface so that the distance between the UAV and the object to be captured reach the selected predetermined distance. In another example, if a vertical value of the image capture device is positive, the image capture device is controlled to have an image capture field above a top side of the UAV and in a direction towards away ground. In this instance, an altitude of the UAV is caused to decrease so that the UAV moves closer to the surface so that the distance between the UAV and the object to be captured reach the selected predetermined distance. In other embodiments, the angle of the image capture device may be user-defined using input via the GUI on the operation panel and the altitude of the UAV is controlled based on the real-time movement of the image capture device via the operation panel. Examples of image capture device angles are further illustrated in FIG. 7.

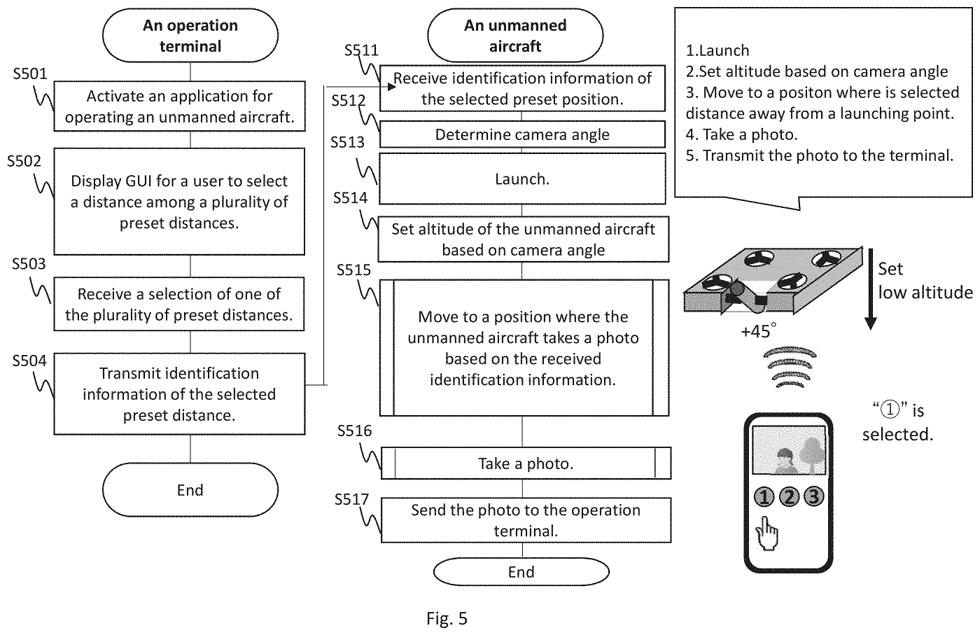

Turning now to FIG. 5, a control algorithm executed by the control device and UAV for controlling image capturing by the UAV from both a preset distance and optimal altitude is described. Steps S501-S504 substantially mirror steps S101-S104 in FIG. 1B and need not be further described as those descriptions are hereby incorporated by reference. Thus, once the control signal with identification information is transmitted to and received by the UAV, further operation will be described. In S511, the control signal is received by the UAV and the identification information corresponding to the selected distance is determined from the control signal. In S512, the UAV performs angle determination processing whereby, prior to launch, an angle of the image capture device relative to a horizontal axis is determined in order to define an altitude at which the UAV is to be controlled to fly when performing image capture processing. Once the angle is determined, the UAV is controlled to launch from a rest position on a surface and fly along a flight path to reach the preset distance and, in doing so, the altitude at which the UAV is to fly is set in S514 based on the determined image capture device angle. As shown in the illustration in FIG. 5, a user manually set the angle of the image capture device to be +45 degrees. This angle is determined and the altitude at which the UAV is to fly is set to be closer to the ground. The altitude is set based, in part on, the altitude of the UAV determined at launch. In one example, the altitude settings may be predetermined altitude settings such that a low altitude setting may be set as “Low=12 inch” and a high altitude setting may be set as “High=80 inch”. The altitude setting values may be adjusted or the setting can be added as user presets that are selectable via the GUI displayed on the operation panel of the control device.

Thereafter in steps S515-S517, the UAV is controlled to fly to the predetermined distance based on the identification information in the control signal, perform image capture processing and transmit the captured image to the control device. The operations performed in S515-S517 mirror those described above with respect to S113-S115 and, as further described in FIGS. 2A-4, the description of which need not be repeated and is hereby incorporated by reference.

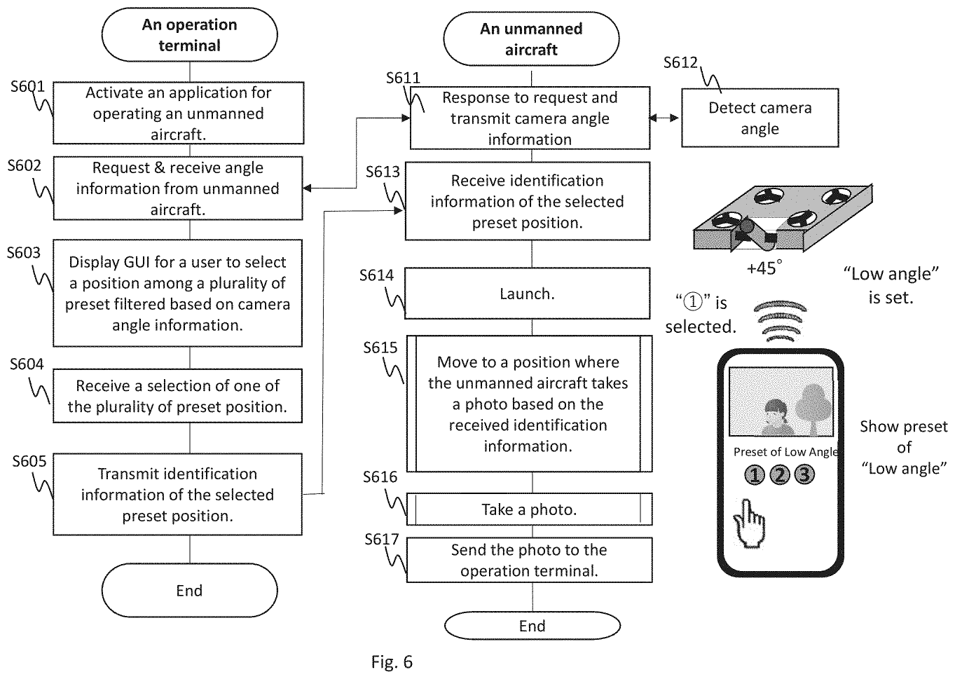

FIG. 6 illustrates another embodiment of a control algorithm for controlling the UAV to reach the distance selected by a user and capture one or more images of the user at the desired distance. Steps S601-S605 are preformed via the operation panel on the control device using the control application executing thereon. The application executed in S601 is a control application that allows a user to interact with the control application to generate control signals including one or more commands for controlling the operation of the UAV. In S602, the control application communicates with the UAV to request and receive angle information therefrom. The angle information corresponds to an angle at which the image capture device on the UAV is positioned. The current position from which the angle information is derived is based on the manual position of the image capture device set by the user. When the control device sends the request in S602, the UAV receives the angle information request at S611 and initiates angle detection processing to determine the angle at which the image capture device is positioned and transmit the determined angle back to the control application executing on the control device.

In S603, the control application causes a graphical user interface (GUI) to be displayed includes one or more user-selectable image elements corresponding to a predetermined flight distance. In generating the display the selectable distances are set based, in part, on the received angle information from S602. In S604, the operation panel receives a selection of one of the image elements from the user. In S605, the control application determines which of the image elements were selected and generates one or more control signals that include one or more commands (e.g. data) that includes identification information corresponding to the selected preset distance based on the received angle information.

In response to the transmission of the control signal in S605, the UAV receives, at S613, the control signal and parses the signal to obtain the identification information corresponding to the preset selected in S604 at the control device. Thereafter, the UAV executes steps S614-S617 which correspond to S112-S115 in FIG. 1B and which are incorporated by reference. In one area of difference, the operation performed in S615 not only includes the processing S113 but also makes use of the angle information that is determined in S611-S612 and which transmitted to the control device so that the presets available for selectin at S603 and S604 take into account the camera angle when determining the position from which the image is to be captured at in S616.

In another embodiment, the positioning of the image capture device on the UAV may be mechanically controlled such that the angle at which the automatically controlled

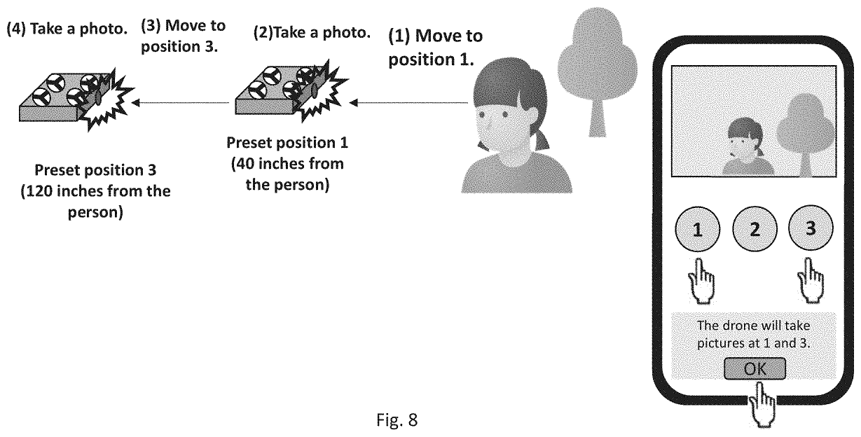

FIG. 8 illustrates an alternative image capturing operation which will be described using the processing steps of FIG. 1B. According to the embodiment illustrated in FIG. 8, a user can select a plurality of predetermined distances from which image capturing is to be performed. In this embodiment, the GUI generated by the control application for display on the operation panel includes the ability to receive more than one selection of image elements that are displayed and registers an order in which the image elements were selected. In one example, after each selection, the manner in which the image element is displayed changes to indicate to the user that the particular image element (and its associated distance and/or altitude). A user can then select an action icon that will register the selection. The distances associated with each selection are then provided as commands in the control signal which transmitted to the UAV. Upon receipt thereof by the UAV, the UAV launches and the propulsion device(s) are operated to cause the UAV to move to the first preset distance selected by a user to perform image capturing. Once completed at the first selected distance, the UAV controls the propulsion device(s) to move to the second selected distance and perform image capturing. The captured images at the respective distances are then transmitted back to the control device for user review and further processing. While this multiple selection operation is described with respect to preset distances, it should be understood that camera angle information and the resulting altitude position control as described above may also be included in the multiple image capture operation described and illustrated herein.

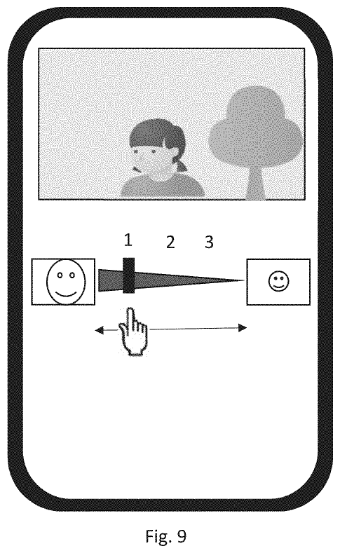

FIG. 9 illustrates an alternative GUI and preset selection mechanism that is generated by the control application. In contrast to the GUI displayed by the control operation illustrated in FIG. 1A whereby a set of image elements corresponding to different distances are displayed, the GUI illustrated in FIG. 9 represents a different manner for selecting the desired distance for which image capture is to be performed. As shown herein, exemplary object sizes are displayed at distal ends of a graduated selection bar having an indicator that represents a particular position that corresponds to a corresponding distance from the object to be captured. In this embodiment the selection received in S103 is based on a touch operation whereby a user touches the indicator displayed on the operation panel (e.g. display) and traverses the surface of the operation panel. The control application translates the touch operation of the indicator into movement and updates a position of the indicator based on the touch operation. The indicator is moveable towards one of the distal ends of the graduated selection bar whereby an end of the graduated selection bar having a wider end indicates that the object to be captured is larger than an end of the selection bar where the width of the selection bar is narrow. When the indicator is moved on the selection bar proximate to the wider end of the selection bar, the control application translates this selection to cause the UAV to be closer to the object being imaged whereas when the indicator is moved towards the narrow end of the selection bar, the control application translates this selection to cause the UAV to be positioned further away from the object to be imaged. In one embodiment, the graduated selection bar may represent a range of predetermined distances whereby each position of the indicator along the selection bar may be translated into unique distances for imaging the object. The actual selection corresponding to the indicator position on the selection bar may be made automatically such as no longer detecting movement of the indictor for a predetermined period of time. Alternatively, further action may be required to register the selection corresponding to the position of the indicator. This may include for example, a tap operation on the indictor or selection of an action icon displayed in the GUI. Once the selection is received as in S103 in FIG. 1B, the control signal is generated and transmitted to control flight and image capturing operation by the UAV. In another embodiment, where the control application is operating in multi-image selection mode, a user can also select multiple distances using the selection bar illustrated in FIG. 9. For example, after moving the indicator to a first position on the selection bar, a user can perform a registration operation (e.g. tap operation) which then causes the control application to generate a second indicator which is also moveable along the selection bar to determine a second distance. In this embodiment, the first selected indicator may remain in a fixed position to provide the use with a reference as to the first selected distance. Alternatively, the GUI may display a marker at the position on the selection bar that corresponds to the first selected distance to provide the reference.

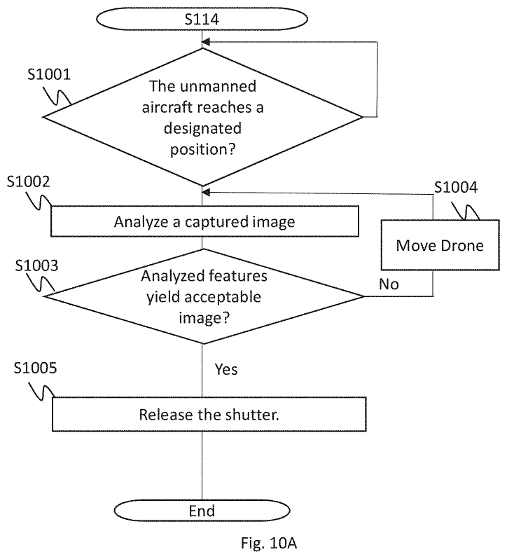

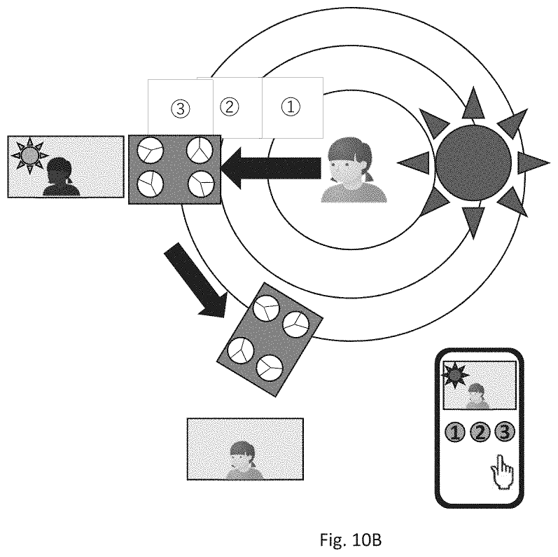

FIG. 10A depicts a control algorithm for image capture processing performed in S114 in FIG. 1B and an illustration of the movement of the UAV in order to perform the image capture operation described in FIG. 10A. In S1001, a determination is made as to whether the UAV has reached the designated position based on the identification information that identifies a distance from an object to be imaged. This determination is continually performed until that position is reached. A live view of the image is analyzed in S1002. The analysis in S1002 is one or more image analysis algorithms to detect objects other than the target object to be imaged and to also detect one or more features of the images. In S1003, a determination is made as to whether the image features analyzed in S1002 indicate that the image is acceptable. If the determination is negative, the one or more propulsion devices of the UAV are controlled to move the UAV in an attempt to obtain a better image. This movement may cause the UAV to move in any direction so long as the distance as prescribed by the original distance selection by the user is maintained. As such, the UAV may move left and/or right in a circumferential path so that the features of the live view image being analyzed are acceptable at which point the shutter is released in S1005. An example of the feature analysis will be described with respect to image brightness and contrast. As shown in FIG. 10B, if the UAV reaches a predetermined position to capture the object but the sun is behind the object, the image will be too bright and there will be a high degree of contrast. In S1002, the live view image being captured is analyzed to detect the features of brightness and contrast. If the result of the image analysis indicates that brightness level and contrast level exceed predetermined levels, either individual thresholds for each feature or a composite threshold based on both features, the determination in S1003 is that the image would be unacceptable and the UAV needs to move directionally. In one embodiment, the directionality of the light captured in the live view image can be analyzed in order to predict a movement direction for the UAV to move in S1004 such that the live view image being captured is acceptable based on the features being analyzed. In another embodiment, the image analysis performed in S1002 analyzed object other than the target object. In the instance shown here, the image analysis detects that the sun is in the image frame. The movement in S1004 causes the UAV to move directionally until such a time that the detected other object (e.g. the sun) is no longer in the live view image frame so that the shutter can be released and the still image captured for transmission to the control device.

While the example of image analysis and movement control processing is described with respect to image brightness and contrast as detected features of the image, these are merely exemplary. Any other image features that are detectable within the image may be substituted or combined with these features in order to direct movement of the UAV to capture the an optimal image. Further, the object detection detecting the sun is also exemplary. It should be understood that supplement object detection to detect any other type of object may also be used in S1002. For example, in a case where a user is the target object to be imaged but the live view image analysis detects one or more other people, the UAV may be controlled to move so that the one or more other people are not in the live view image frame. This supplemental object detection can be performed to detect any type of other object in the frame and cause the UAV to reposition but maintain the desired distance as selected by the user.

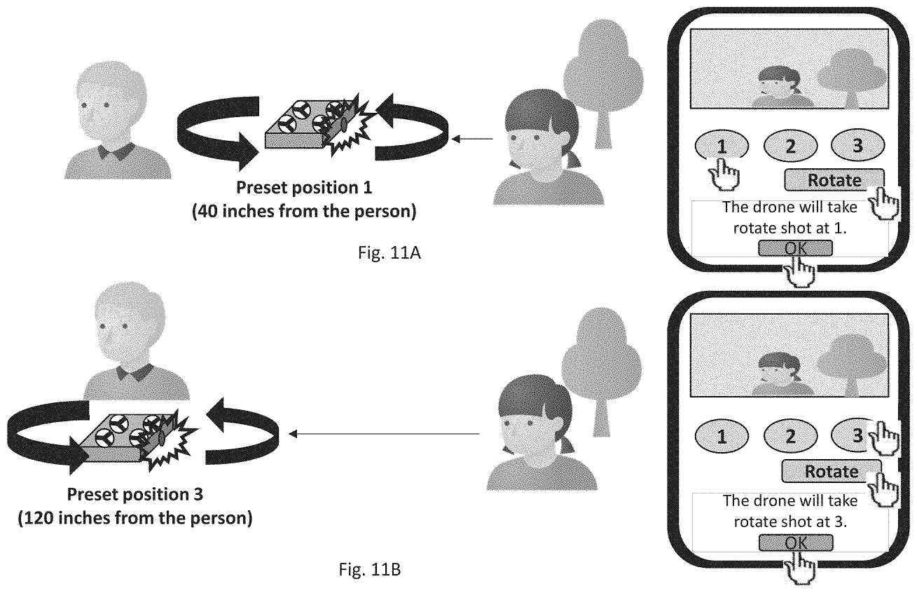

FIGS. 11A and 11B illustrate a further embodiment for the image capturing operation of S114 of FIG. 1B. In these embodiments, the GUI displayed on the operation panel includes an image element that, when selected controls the image capture device on the UAV to maintain its current flight position (e.g. hover) and initiate capturing a series of images while the UAV rotates a predetermined number of degrees about its current flight position. In one example a series of images are captures in a full 360 degree rotation of the UAV. As shown in FIG. 11A, a user had selected, via the GUI on the operation panel, the first predetermined distance image element and then the rotation action image element. The control signal generated by the control application combines the distance information and rotation commands therein and transmits the control signal to the UAV. The UAV then moves to the predetermined distance in a manner similar to that which is described above and begins to rotate and capture a series of images as the UAV rotates. These images are then transmitted back to the control device for display to the user. FIG. 11B illustrates similar processing with the exception that the user selected the third predetermine distance. As such, further description is not needed.

In other embodiments, the a user may still select more than one distance from which images are to be captured and can selectively assign rotation to occur at one or more of the selected distances. For example, a user can select the first predetermined distance without rotation, followed by the third predetermined distance without rotation and finally the second predetermined distance with rotation. The control signal can be generated to include any and all commands received via the operation panel on the control device.

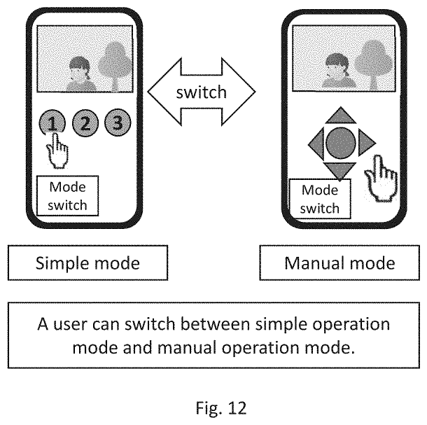

FIG. 12 illustrates an exemplary GUI displayed on the operation panel. In this embodiment, the control application may switch between a first mode of operation and a second mode of operation by selection of a designated image element within the GUI. For example, in a first mode of operation, the GUI on the operation panel may display a set of selectable image elements that correspond to preset distances to which the UAV is controlled to fly and capture images. In response to selection of the designated mode control image element, the control application switches control processing to a second mode which provides for manual control of the UAV. In doing so, the control application causes a different GUI to be displayed with different control image elements that are able to receive inputs from the user. As shown herein, the control image elements are directional controls representing up, down, left and right movements to be transmitted to and used for controlling the UAV. However, the GUI may also just display a single input region that will cause the UAV to move directly in response to the direction of movement entered in the input region. In this second mode of operation, a more consistent connection between the control device and the UAV is required so that movement commands can be continually transmitted from the control device to the UAV in order to control the one or more propulsion devices of the UAV to move the UAV in the direction corresponding to the user input. These modes can be switched on the fly during flight by the UAV.

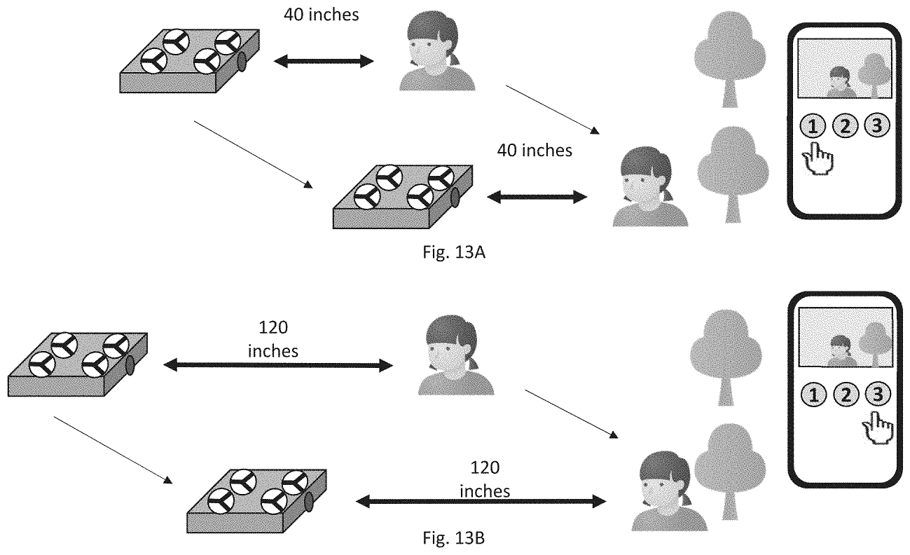

FIGS. 13A and 13B illustrate another embodiment of the image capturing operation of S113 and S114 of FIG. 1B. As illustrated herein, the UAV includes an object tracking algorithm that is executed in conjunction with the distance control algorithm controlling the flight path of the UAV. In FIG. 13A, the selected distance is the first predetermined distance and, as the object moves laterally, the object tracking algorithm locks onto the object and controls the propulsion device(s) to cause the UAV to move such that the selected predetermine distance between the UAV and the object is maintained. In FIG. 13, similar processing is performed to maintain the distance between the UAV and the object to be the third predetermined distance.

An exemplary object tracking algorithm includes determining a target size of the target object such as the face of a user when the designated distance is between the target object and the UAV. The algorithm locks on to at least part of the target object and continually detects a size change of the at least the part of the target object and, if the target size decreases, the UAV is caused to move closer to the object until the target size is once again reached. If the target size increases, the UAV is caused to move away from the object until the target size is once again reached. This detection and movement control is continually performed until the image capture device captures the image of the target object. Another aspect of the object tracking algorithm may include maintaining the detected object at a predetermined position within the image frame. For example, the image capture algorithm may be programmed to keep the target object in substantially the center of the frame. If the target object shifts position within the frame, the UAV is controlled to move laterally and/or rotationally so that the target object is in the desired position within the frame. In an instance where there are more than one of the same type of target objects (e.g. multiple people), the target tracking selects a particular one of the objects to track. For example, the tracking algorithm may select the largest or smallest of the plurality of objects to be the target object and base all other control thereon. Alternatively, the tracking algorithm may select the most centrally located object within the frame as the target object and maintain the distance based on that selection. In an instance where no target items are detected, the tracking algorithm may control the UAV to rotate about its current position to determine if any target objects are within a 360 degree range of the UAV. Should no target objects be detected, the UAV may communicate an instruction message back to the control device indicating that no such objects are detected and recommend someone move into the field of view of the image capture device.

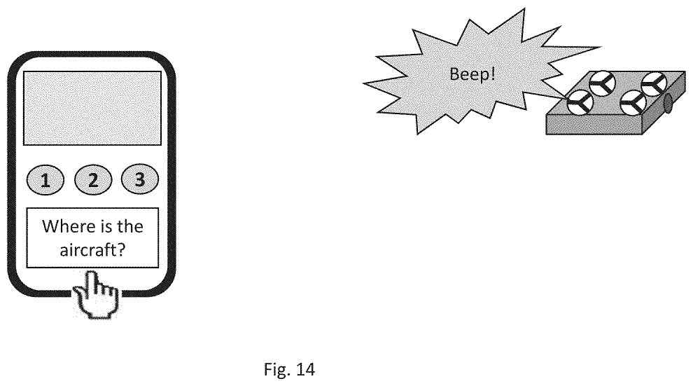

FIG. 14 illustrates a further GUI generated by the control application for display on the operation panel. The GUI illustrated in FIG. 14 enables a user to select an image element that controls a location request to be issued from the control device to the UAV in order for the user to locate the UAV. In response to selecting the locate image element, the location request signal is generated and transmitted to the UAV. The UAV, upon receipt of the location request signal, activates a location identifier to notify the user where the UAV is presently located. In one embodiment, the location identifier is a speaker that outputs an audible sound. In another embodiment, the location identifier is one or more lights that can be selectively illuminated to notify the user of the location of the UAV. In a further embodiment, the location request signal may cause the UAV to launch from a present position and initiate image capturing of the surrounding area so that those images can be transmitted to the control device and viewed by the user in case the user is out of range for visual or audible indication.

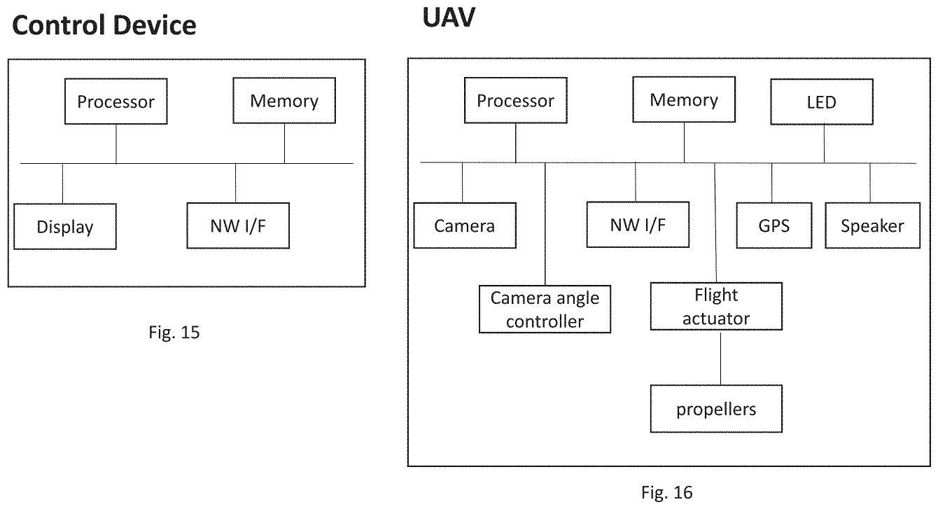

FIGS. 15 and 16 are block diagrams illustrating the hardware for controlling the operation of the control device and UAV, respectively. Each of the control device and the UAV include at least one processor or CPU and one or more memories which store instructions that are executed by the one or more processors to control the respective device to perform is described operations. The one or more memories may include one or more RAMs and/or ROMS. For example, an electrically erasable programmable read-only memory (EEPROM). In the ROM, control programs and instructions that are executed by the processor are stored. Such programs are programs, when executed by one or more of the processors, cause the one or more processors to perform the operations and/or functions in the various flowcharts described hereinabove. The one or more memories also include random-access memory (RAM) is used as a system memory which operate as a work area for the data associated with execution of the control programs by the one or more processors. As part of the processor, a system timer may be included which measures the time for various controls and the time of a built-in clock. Each of the control device and UAV includes a network connection interface which allows for communication via local area network and/or wide area network. The communication facilitated by the network connection interface may include wired communication such as by Ethernet cable connection and/or wireless communication including short and long distance wireless communication such as WiFi, Bluetooth, NFC and the like.

The control device also includes a display (e.g. operation panel) which is preferably touch sensitive such that touch operations can be translated into electrical signals to generate control commands. The display selectively displays one or more GUIS generated by the one or more applications executing on the control device and provide the user with the ability to selectively interact with and control the UAV by selecting image elements that are translated into commands which are transmitted from the network interface of the control device and received by the network interface of the UAV and used to control operations of the UAV.

As shown in FIG. 16, in addition to the above common type components, the UAV includes at least one indicator for providing a notification to a user. As shown herein, the at least one indicator includes at least one LED light that can be selectively illuminated and a speaker for audibly outputting a notification to a user. A GPS unit is further provided that is able to obtain GPS coordinate data for the UAV to determine and modify its position based thereon. A flight actuator is provided which selectively controls one or more propulsion devices (e.g. propellers) to rotate at a given speed and shift direction in order to cause the UAV to move in a particular direction as described above. The UAV also includes a camera angle controller that controls an angular position of the image capture device (e.g. camera) of the UAV so that images can be captured thereby and transmitted back to the control device via the network interface of the UAV.

We claim:

1. (canceled)

2. (canceled)

3. (canceled)

4. (canceled)

5. An unmanned autonomous vehicle comprising:
at least one propulsion device;
at least one image capture device;
at least one adjusting member to adjust an tilt angle of the image capture device;
one or more processors; and
one or more memories storing instructions that, when executed, configures the one or more processors to:
receive, from a control device, a capturing instruction to capture at least one image;
acquire, based on a position of the at least one adjusting member, angle information indicating a tilt angle of the image capture device; and
control, in a case where the capturing instruction is received, the propulsion device so that the image capture device captures at least one image at an altitude which is determined based on the acquired angle information.

6. The unmanned autonomous vehicle according to claim 5, wherein the execution of the instructions further configures the one or more processors to:
control the propulsion device so that the image capture device captures at least one image at a first altitude in a case where the acquired tilt angle indicates that the image capture device is angled in an upward direction; and
control the propulsion device so that the image capture device captures at least one image at a second altitude in a case where the acquired tilt angle indicates that the image capture device is angled in a downward direction,
wherein the first altitude is lower than the second altitude.

7. The unmanned autonomous vehicle according to claim 5, wherein the execution of the instructions further configures the one or more processors to:
receive, from the control device, the capturing instruction including distance information indicating a distance to a position where the image capture device captures at least one image; and
control, in a case where the capturing instruction is received, the propulsion device so that the image capture device captures at least one image at a distance corresponding to the capturing instruction.

8. (canceled)

9. The unmanned autonomous vehicle according to claim 5, wherein the execution of the instructions further configures the one or more processors to:
receive, from the control device, the capturing instruction indicating selections of a first preset distance and a second preset distance; and
control, in a case where the capturing instruction indicating selections of the first preset distance and the second preset distance is received, the propulsion device so that the image capture device captures images at a distance corresponding to the first preset distance and at a distance corresponding to the second preset distance.

10. The unmanned autonomous vehicle according to claim 5, wherein the execution of the instructions further configures the one or more processors to:
receive, from the control device, the capturing instruction including distance information indicating a distance to a position where the image capture device captures at least one image;
detect an object in a captured image captured by the image capture device;
determine a distance from the detected object to the unmanned autonomous vehicle based on a size of the detected object; and
control the propulsion device so that the image capture device captures at least one image at a distance corresponding to the capturing instruction from the object.

11. (canceled)

12. (canceled)

13. The unmanned autonomous vehicle according to claim 5, wherein the execution of the instructions further configures the one or more processors to:
detect a plurality of objects having a predetermined feature in a captured image captured by the image capture device;
select one of the plurality of objects;
control the propulsion device so that the image capture device captures at least one image at a distance corresponding to the capturing instruction from the selected object.

14. (canceled)

15. (canceled)

16. The unmanned autonomous vehicle according to claim 5, wherein the execution of the instructions further configures the one or more processors to:
receive, from the control device, the capturing instruction indicating a selection of a one of preset distances and a rotate instruction; and
control, in a case where the capturing instruction indicating the selection of the one of the preset distances and the rotate instruction are received, the propulsion device so that the image capture device capture images at a distance corresponding to the selected preset distance by rotating the unmanned autonomous vehicle horizontally.

17. (canceled)

18. A method of controlling an unmanned autonomous vehicle that includes at least one propulsion device, at least one image capture device and at least one adjusting member to adjust an tilt angle of the image capture device, the control method comprising:
receive, from the control device, a capturing instruction to capture at least one image;
acquiring, based on a position of the at least one adjusting member, angle information indicating a tilt angle of the image capture device; and
controlling, in a case where the capturing instruction is received, the propulsion device so that the image capture device captures at least one image at an altitude which is determined based on the acquired angle information.

19. The method according to claim 18, further comprising:
controlling the propulsion device so that the image capture device captures at least one image at a first altitude in a case where the acquired tilt angle indicates that the image capture device is angled in an upward direction; and
controlling the propulsion device so that the image capture device captures at least one image at a second altitude in a case where the acquired tilt angle indicates that the image capture device is angled in a downward direction,
wherein the first altitude is lower than the second altitude.

20. The method according to claim 18, further comprising:
receiving, from the control device, the capturing instruction including distance information indicating a distance to a position where the image capture device captures at least one image; and
controlling, in a case where the capturing instruction is received, the propulsion device so that the image capture device captures at least one image at a distance corresponding to the capturing instruction.

21. (canceled)

22. The method according to claim 18, further comprising:
receiving, from the control device, the capturing instruction indicating selections of a first preset distance and a second preset distance; and
controlling, in a case where the capturing instruction indicating selections of the first preset distance and the second preset distance is received, the propulsion device so that the image capture device captures images at a distance corresponding to the first preset distance and at a distance corresponding to the second preset distance.

23. The method according to claim 18, further comprising:
receive, from the control device, the capturing instruction including distance information indicating a distance to a position where the image capture device captures at least one image;
detecting an object in a captured image captured by the image capture device;
determining a distance from the detected object to the unmanned autonomous vehicle based on a size of the detected object; and
controlling the propulsion device so that the image capture device captures at least one image at a distance corresponding to the capturing instruction from the object.

24. (canceled)

25. (canceled)

26. The method according to claim 18, further comprising:
detecting a plurality of objects having a predetermined feature in a captured image captured by the image capture device;
selecting one of the plurality of objects;
controlling the propulsion device so that the image capture device captures at least one image at a distance corresponding to the capturing instruction from the selected object.

27. (canceled)

28. (canceled)

29. The method according to claim 18, further comprising:
receiving, from the control device, the capturing instruction indicating a selection of a one of preset distances and a rotate instruction; and
controlling, in a case where the capturing instruction indicating the selection of the one of the preset distances and the rotate instruction are received, the propulsion device so that the image capture device capture images at a distance corresponding to the selected preset distance by rotating the unmanned autonomous vehicle horizontally.

30. (canceled)
